(19) United States
(12) Patent Application Publication
(10) Pub. No.: US 2008/0152123 A1
(43) Pub. Date: Jun. 26, 2008

(54) SYSTEM AND METHOD FOR CONVERGENCE OF DUAL-MODE PHONE SERVICES WITH FIXED-LINE VoIP SERVICES BASED ON LOCATION-PROXIMITY

(75) Inventors: Rajesh S. Pazhyannur, Lake Zurich, IL (US); Mansoor Basha, Hoffman Estates, IL (US); Robert D. Battin, Kildeer, IL (US); Peter A. Lin, Lisle, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,505

(22) Filed: Dec. 20, 2006

(51) Int. Cl. H04M 1/00

(52) U.S. Cl. 379/373.01

(57) ABSTRACT

The present invention provides a method and system for facilitating ringing of one or more dual mode communication devices and one or more fixed communication devices in an IP-based communication system. The method comprises receiving a first invite message corresponding to an incoming call for dual mode communication device or the fixed communication device. The method further comprises determining whether the dual mode communication device and the fixed communication device are located within a predetermined area. When the dual mode communication device and the fixed communication device are located within a predetermined area, the method determines whether a simultaneous ringing feature is active. If the simultaneous ringing feature is active, both the dual mode communication device and the fixed communication device are allowed to join the incoming call simultaneously.

### FIELD OF INVENTION

The present invention relates generally to communication networks and more specifically to providing a system and methods for facilitating simultaneous ringing of one or more dual mode communication devices and one ore more fixed communication devices.

### BACKGROUND OF THE INVENTION

The emergence of the Internet has enabled IP based communication like Voice over Internet Protocol (VoIP) important and popular. The deployment of VoIP phones in urban households is a common phenomenon nowadays. A typical VoIP phone has an analog terminal adapter, which converts a Plain Old Telephone Service (POTS) phone into a Session Initiation Protocol (SIP) based VoIP phone. For the conversion, the terminal adaptor connects to the POTS phone and in-turn interworks with a VoIP server through a broadband connection provided by, for instance, a Digital Subscriber Line (DSL) or a cable system.

Recent trends in IP based communication technology have given opportunities for the development of new technologies like Unlicensed Mobile Access (UMA), also known in the art as Generic Access Network (GAN). UMA enables access to mobile voice, data, and IP Multimedia Subsystem (IMS) services over IP broadband access and unlicensed spectrum technologies such as Wireless Fidelity (Wi-Fi). Consequently, UMA describes a telecommunication network that allows seamless roaming and handover between Wireless Local Area Networks (WLAN) and Wide Area Networks (WAN) using dual mode communication devices. The WLAN, for instance, can be based on private unlicensed spectrum technologies, for example, Bluetooth, Wi-Fi or 802.11. The WAN on the other hand can be based on, for example, Global System Mobile (GSM), General Packet Radio Service (GPRS) etc. UMA is therefore, an attempt towards convergence of mobile, fixed and Internet telephony.

The integration of WLAN and WAN in UMA has opened new opportunities for service providers to provide enhanced services and simplify communication for users. For example, it is now possible for a user of a dual mode mobile device to selectively switch between WLAN and WAN to communicate with other users and access other services.

Some existing technologies enable simultaneous ringing of multiple phones conditionally such as based on time of day. For example, a product called BroadWorks™ features simultaneous ringing of wireless phones. However, known methods cannot be applied directly to a case where one of the devices is a dual mode UMA phone and another phone is a fixed-line phone serviced by IMS. Further, current methods do not consider the user's location when activating features such as simultaneous ringing of the users' dual mode communication devices and the users' fixed communication devices, such as in-home telephones.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is an exemplary representation of an IP based communication network 100 in accordance with various embodiments of the present invention.

FIG. 2 is a block diagram of a server for facilitating ringing a dual mode communication device and a fixed communication device in an IP based communication system in accordance with an embodiment of the present invention.

FIG. 3 is a flow diagram of a method for facilitating ringing a dual mode communication device and a fixed communication device in an IP based communication system in accordance with an embodiment of the present invention.

FIG. 4 is a flow diagram of a method for enabling the fixed communication device to join an incoming call, when the incoming call is for the dual mode communication device in accordance with an embodiment of the present invention.

FIG. 5 is a flow diagram of a method for enabling the dual mode communication device to join an incoming call, when the incoming call is for the fixed communication device in accordance with an embodiment of the present invention.

FIG. 6 is a call flow diagram of an exemplary scenario where an incoming call is received for a dual mode communication device in accordance with an embodiment of the present invention.

FIG. 7 is a call flow diagram of an exemplary scenario where an incoming call is received for a fixed communication device in accordance with an embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a system and methods for facilitating convergence of VoIP services and dual mode services. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the present invention described herein may be comprised of one or more conventional processors and unique stored program instructions that control the one or more processors to implement, in conjunction with certain non-processor circuits, some, most, or all of the functions of a system and methods for facilitating convergence of VoIP services and dual mode services described herein. The non-processor circuits may include, but are not limited to, a radio receiver, a radio transmitter, signal drivers, clock circuits, power source circuits, and user input devices. As such, these functions may be interpreted as steps of methods for facilitating convergence of VoIP services and dual mode services described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention provides a system and method for facilitating convergence of VoIP services and dual mode services. More particularly, the present invention provides a system and method for facilitating ringing of one or more dual mode communication devices and one or more fixed communication devices in an IP based communication system, if the dual mode communication device(s) and fixed communication device(s) are located within a predetermined area. A dual mode communication device may be, for example, a Wireless LAN (WLAN)-GSM mobile phone based on the UMA technology. For the sake of clarity, the dual mode communication devices discussed herein are based on UMA technology. However, it will be appreciated that the dual mode communication devices may be based on any technology that supports a dual-mode communication service, and all such embodiments are within the scope of the present invention. Further, the fixed communication devices are IP enabled and may communicate with other communication devices using a Voice over Internet Protocol (VoIP) service. For example, the fixed communication devices may be for example, but not limited to, LAN phones, WLAN phones etc. The predetermined area is generally a location area, such as home or office, serviced by the VoIP service using broadband networks such as Digital Subscriber Line (DSL) or Cable. The dual mode communication devices in the predetermined area can connect to the DSL or Cable using the Wi-Fi service. A wireless communication access point corresponding to the Wi-Fi service may be installed in the predetermined area.

In accordance with various embodiments of the present invention, when an incoming call arrives for a dual mode communication device or a fixed communication device in the predetermined area, the dual mode communication device and the fixed communication device in the predetermined area are enabled to ring simultaneously. The present invention allows a user to answer the incoming call from either a dual mode communication device or from a fixed communication device present in the predetermined area irrespective of which communication device the incoming call is originally meant for.

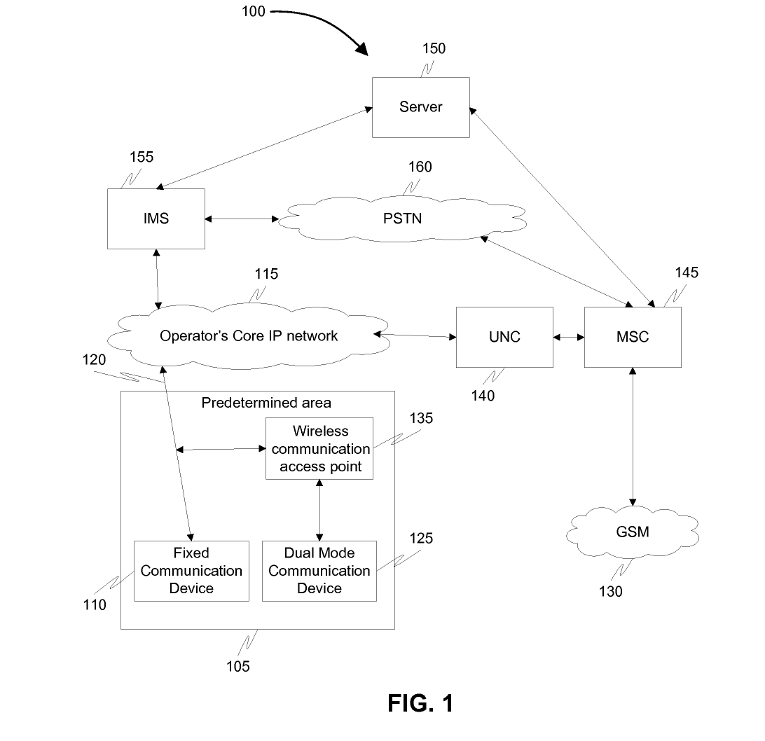

Referring now to the drawings, and in particular to FIG. 1, an exemplary representation of a broadband modem 100 is shown in accordance with various embodiments of the present invention. The modem 100 comprises a predetermined area 105. The predetermined area 105 can be, for instance, the user's home or the user's office. A VoIP service may be provided to a plurality of fixed communication devices in the predetermined area 105 using broadband networks such as DSL or Cable. Further, a WLAN may also service the predetermined area 105. The WLAN, for instance, may be based on private unlicensed spectrum technologies like Bluetooth or 802.11. One of the plurality of fixed communication devices is depicted as a fixed communication device 110. In one embodiment of the present invention, the fixed communication device 110 is a Session Initiated Protocol (SIP) based phone. In another embodiment of the present invention, the fixed communication device 110 is a RJ-11 based phone, where the predetermined area 105 comprises a residential gateway that performs SIP to analog adaptation.

The IP based communication network 100 may further comprise an operator's core IP network 115. The operator's core IP network 115 provides routing and transport of IP packets between various communication network elements. Specifically, the operator's core IP network supports the VoIP service in the predetermined area 105. The fixed communication device 110 may be connected to the operator's core IP network 115 via a broadband connection 120. Those skilled in the art will realize that any high-speed Internet connection can be used to connect to the operator's core IP network 115 instead of the broadband connection 120.

In accordance with FIG. 1, a dual mode communication device (“DMCD”) 125 roams into the predetermined area 105. The DMCD 125 may be based on a UMA technology. The UMA technology provides mobile service using a GSM service 130 outside the predetermined area 105 and a Wi-Fi service inside the predetermined area 105. A wireless communication access point 135 facilitates the Wi-Fi service inside the predetermined area 105. Specifically, the wireless communication access point 135 is connected to the broadband connection 120 provided by, for example, a DSL or a Cable modem. The DMCD 125 may need to register with the wireless communication access point 135 upon the DMCD 125 entering the predetermined area 105. The IP based communication network 100 comprises a UMA Network Controller (UNC) 140, which controls the mobile services being provided to the DMCD 125. The DMCD 125 may also need to register with the UNC 140. The UNC 140 is connected to the operator's core IP network 115 and a Mobile Switching Center (MSC) 145 corresponding to the GSM service 130.

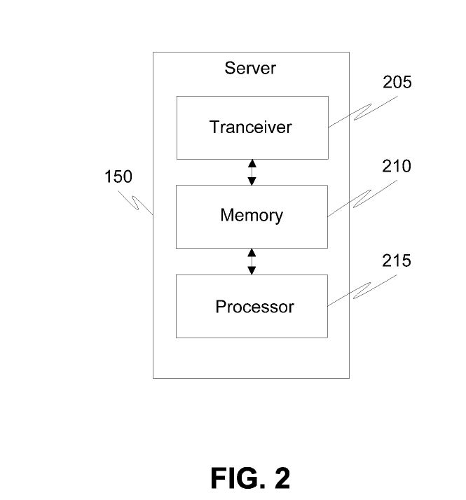

In accordance with the present invention, the IP based communication network 100 also comprises a server 150. The server 150 is configured to facilitate ringing of at least the DMCD 125 and the fixed communication device (“FCD”) 110 when the DMCD 125 is in the predetermined area 105. Various components of the server 150 are described in detail in conjunction with FIG. 2. The server 150 may be adaptively connected to an IP Multimedia Subsystem component (IMS) 155. The IMS 155 enables telecom operators to provide mobile and fixed multimedia services as commonly known in the art. For instance, the IMS 155 uses VoIP and supports existing phone systems such as packet-switched telephony system (PSTN) 160.

In accordance with an embodiment of the present invention, ringing of the DMCD 125 and the FCD 110 occurs sequentially when an incoming call for either the DMCD 125 or the FCD 110 is received. For example, when an incoming call is received for the DMCD 125, the DMCD 125 will start ringing before the FCD 110 if the DMCD 125 is in the predetermined area 105. An embodiment where the FCD 110 starts ringing before the DMCD 125 is also within the scope of the present invention. Those skilled in the art will realize that the above recognized advantages and other advantages described herein are merely exemplary and are not meant to be a complete rendering of all of the advantages of the various embodiments of the present invention.

Referring now to FIG. 2, a block diagram of the server 150 for facilitating ringing of one or more DMCDs and one or more FCDs in an IP based communication system is shown in accordance with an embodiment of the present invention. The server 150 includes a transceiver 205, a memory 210 and a processor 215. The processor 215 can be operatively coupled to one or more of the transceiver 205 and the memory 210.

In accordance with various embodiments of the present invention, the DMCD 125 is configured with a personal number, whereas the FCD 110 is configured with a family number. The memory 210 can comprise a user profile database where one or more of the family number and the personal number are stored.

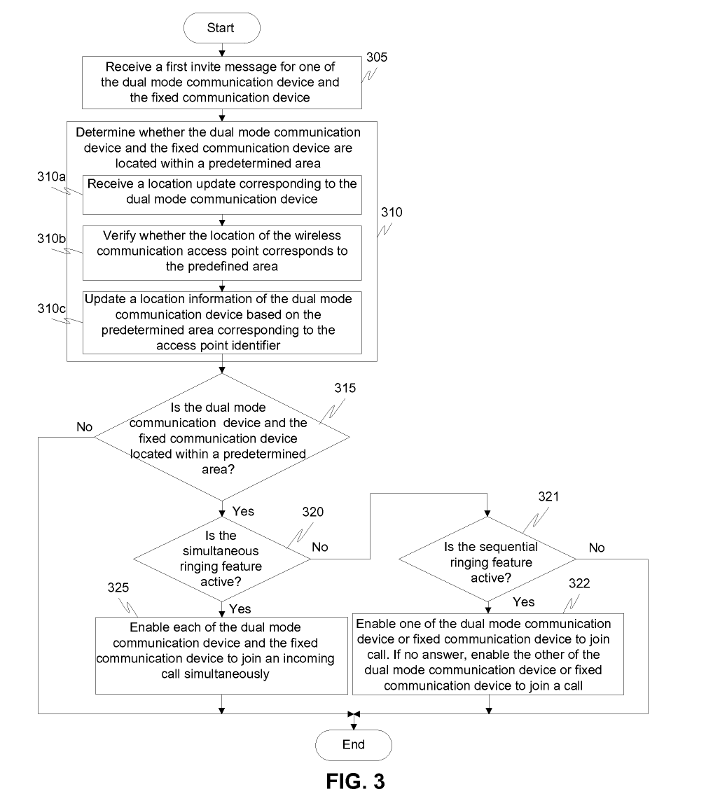

Referring now to FIG. 3, when an incoming call is received for either a user's personal number or family number, the transceiver 205 receives a first invite message corresponding to the incoming call (step 305). Upon receiving the first invite message, the processor 215 determines whether the DMCD 125 and the FCD 110 are located within the predetermined area 105 (step 310). (In an alternate embodiment of the present invention, the determining step, step 310, is performed by the server 150 of FIG. 1.) For determining whether the DMCD 125 and the FCD 110 are in the predetermined area 105, the transceiver 205 receives a location update corresponding to the DMCD 125 (step 310a). In one embodiment of the present invention, the DMCD 125 sends the location update to the server 150. In an alternate embodiment, the UNC 140 sends the location update corresponding to the DMCD 125 to the server 150. The location update may include one or more of a device identifier of the DMCD 125 and an access point identifier of the wireless communication access point 135. The device identifier may include an identification number of the DMCD 125. The identification number enables the server 150 to recognize the DMCD 125. Similarly, the access point identifier may include an identification number corresponding to the wireless communication access point 135. The identification number conveys the location of the wireless communication access point 135 to the server 150. In an embodiment of the present invention, the location of the wireless communication access point 135 is the predetermined area 105 (step 310b).

In an embodiment of the present invention, the processor 215 is configured to update the location information of the DMCD 125 based on the predetermined area 105 corresponding to the access point identifier (step 310c). Further, the location update corresponding to the DMCD 125 is received at the transceiver 205 periodically over a first predetermined interval of time. If a location update is not received by the processor within a second predetermined interval of time, the processor 215 resets the location information of the DMCD 125 to a cellular location. The cellular location corresponds to the WAN servicing the DMCD 125.

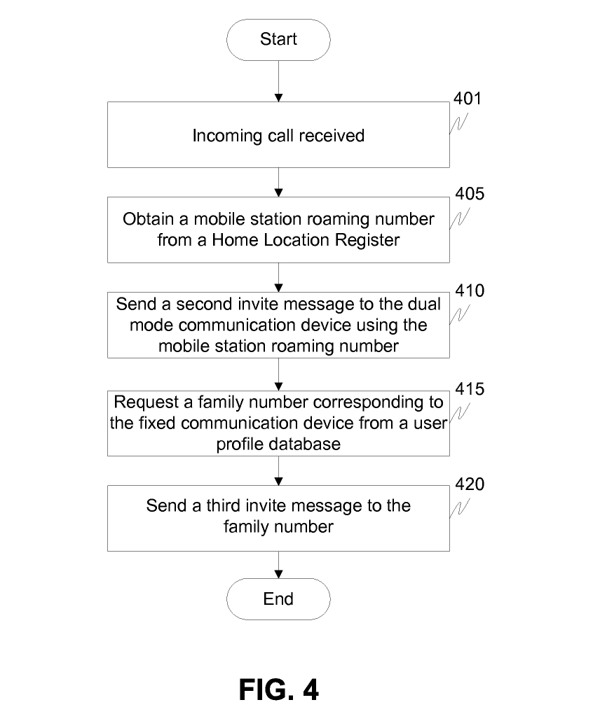

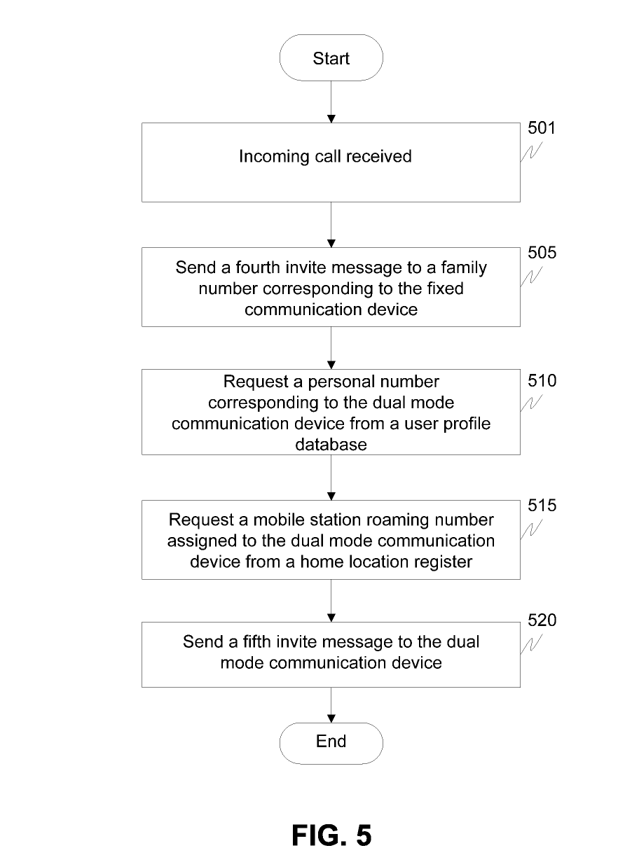

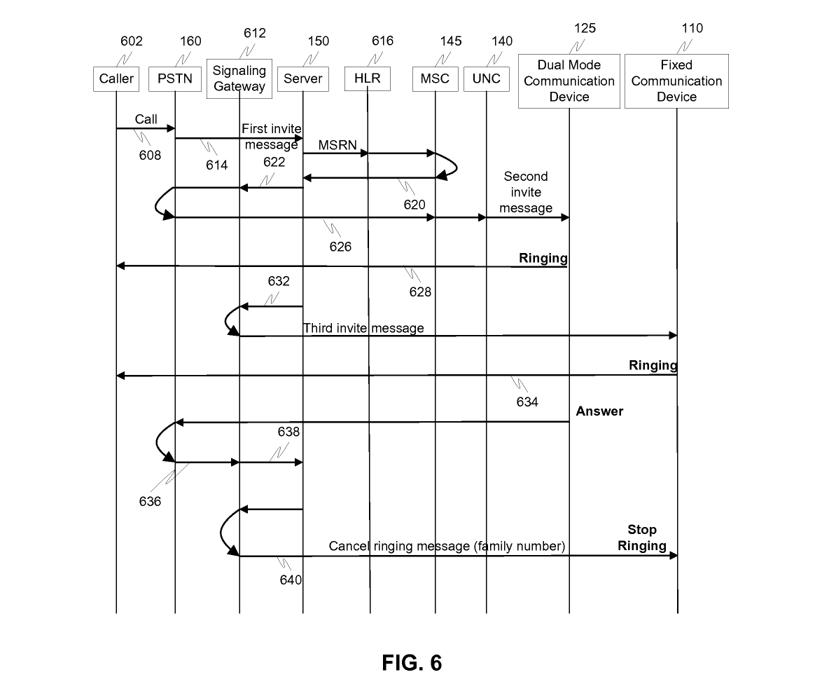

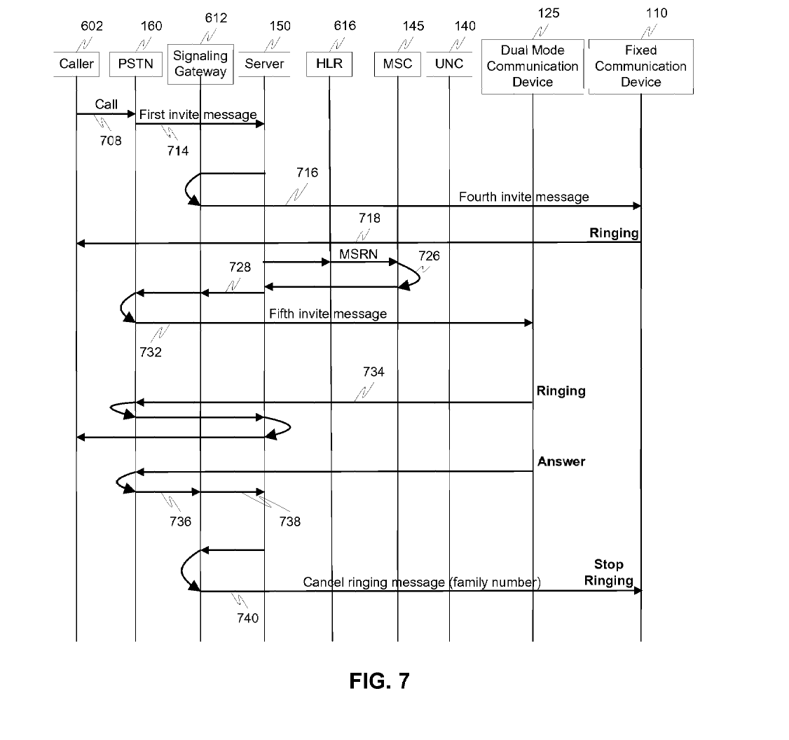

Upon determining that both the DMCD 125 and the FCD 110 are within the predetermined area 105 (step 315), the processor 215 determines whether a simultaneous ringing feature is active (step 320). (In an alternate embodiment of the present invention, step 320 is performed by the server 150 of FIG. 1.) If the simultaneous ringing feature is active, the processor 215 enables the DMCD 125 and the FCD 110 to join the incoming call simultaneously (step 325) and the process ends. A method of enabling the DMCD 125 to join in an incoming call that is meant for the FCD 110 is explained in conjunction with FIG. 4 and FIG. 6. Further, a method of enabling the FCD 110 to join in an incoming call that is meant for the DMCD 125 is explained in conjunction with FIG. 5 and FIG. 7. If, at step 320, the simultaneous ringing feature is not active, the processor 215 determines whether a sequential ringing feature is active (step 321). If the sequential ringing feature is active, the processor 215 enables the dual mode communication device and the fixed communication device to join the incoming call sequentially (step 322). In particular, the processor 215 enables one of the dual mode communication device or fixed communication device to join the incoming call. If the one enabled does not join the call (answer the call), the processor 215 enables the other of the dual mode communication device or fixed communication device to join the call. Then the process ends.

Referring now to FIG. 4, a flow diagram of a method for enabling the FCD 110 to join an incoming call, when the incoming call is for the DMCD 125 is shown in accordance with an embodiment of the present invention. At step 401, an incoming call is received. At step 405, a mobile station roaming number (MSRN) corresponding to the DMCD 125 is obtained from a Home Location Register (HLR) of the GSM 130. Specifically, the HLR retrieves the MSRN assigned to the DMCD 125 using the personal number associated with the DMCD 125. In an embodiment of the present invention, the server 150 of FIG. 1 can send a request to the HLR for the MSRN.

At step 410, a second invite message is sent to the DMCD 125 using the MSRN. The server 150 of FIG. 1 may send the second invite message to the DMCD 125. Consequently, the DMCD 125 starts ringing.

To enable the FCD 110 to ring in response to the incoming call, a family number corresponding to the FCD 110 is requested from a user profile database, at step 415. For instance, the family number may be associated with the personal number in the user profile database. Thus, the family number of the FCD 110 may be retrieved based on the personal number. As mentioned earlier, in an embodiment of the present invention, the user profile database resides in the memory 210 of FIG. 2. The family number corresponding to the FCD 110 is an identification of the FCD 110 and is used by an IMS for the purpose of routing incoming calls to the FCD 110. At step 420, a third invite message is sent to the family number corresponding to the FCD 110. Consequently, the FCD 110 starts ringing in response to the third invite message. A call flow diagram illustrating the method of FIG. 4 will now be described with reference to FIG. 6.

Referring now to FIG. 6, a call flow diagram of an exemplary scenario where an incoming call is received for the DMCD 125 is shown in accordance with an embodiment of the present invention. A caller 602 may dial a user's personal number to place a call to the DMCD 125. The incoming call from the caller 602 is routed to the PSTN 160 at step 608. In response to the incoming call, a first invite message is generated and routed to the server 150 via a signaling gateway 612 at step 614. In response to the first invite message, the server 150 communicates with a HLR 616 associated with the GSM of the DMCD 125. The HLR 616 further coordinates with the Mobile Switching Center (MSC) 145 in order to obtain a MSRN corresponding to the DMCD 125 at step 620. The server 150 forwards the MSRN of the DMCD 125 to the signaling gateway 612 at step 622. Using the MSRN, the signaling gateway 612 sends a second invite message to the DMCD 125 via the MSC 145 and the UNC 140 at step 626. Specifically, the MSC 145 places a page request to the UNC 140 resulting in a traffic channel setup between the UNC 140 and the DMCD 125. The caller 602 receives a ringing tone from the DMCD 125 at step 628.

If both the DMCD 125 and the FCD 110 are in a predetermined area, the sever 610 obtains a family number corresponding to the FCD 110 from a user profile database. Using the family number, the signaling gateway 612 sends a third invite message to the FCD 110 at step 632. In response to the third invite message, a ringing tone corresponding to the FCD 630 is received by the caller 602 at step 634.

Those skilled in the art will appreciate that the incoming call can be answered using the DMCD 125 or the FCD 630. However, for illustrative purposes, the incoming call is answered using the DMCD 125. When the incoming call is answered by the DMCD 125, the signaling gateway 612 is informed at step 636. The signaling gateway 612, in turn, informs the server 150 at step 638. The server 150 then sends a cancel ringing message to the FCD 630 via the signaling gateway 612 at step 640. Consequently, the FCD 630 stops ringing.

As described with reference to FIGS. 4 and 6 above, the present invention enables both the DMCD 125 and the FCD 110 to ring in response to a call for the DMCD 125, when both the DMCD 125 and FCD 110 are in the predetermined area 105. In an embodiment of the present invention, both the DMCD 125 and the FCD 110 ring simultaneously. In an alternate embodiment, the DMCD 125 and the FCD 110 may ring sequentially.

Referring now to FIG. 5, a flow diagram of a method for enabling the DMCD 125 to join an incoming call, when the incoming call is for the FCD 110 is described. At step 501, an incoming call is received. At step 505, a fourth invite message is sent to the family number corresponding to the FCD 110. The server 150 of FIG. 1 may send the fourth invite message to the family number. The FCD 110 starts ringing in response to the fourth invite message.

To enable the DMCD 125 to ring in response to the incoming call, the personal number corresponding to the DMCD 125 is requested from a user profile database at step 510. For instance, the personal number may be associated with the family number in the user profile database. Thus, the personal number of the DMCD 125 can be retrieved based on the family number. The user profile database, in accordance with one embodiment of the present invention, is stored in the memory 210 of the server 150 of FIG. 2. At step 515, a MSRN corresponding to the DMCD 125 is requested from the HLR. In one embodiment of the invention, the server 150 requests the MSRN from the HLR based on the personal number. Using the MSRN of the DMCD 125, a fifth invite message is sent to the DMCD 125 at step 520. Consequently, the DMCD 125 starts ringing. A call flow diagram illustrating the method of FIG. 5 will now be described with reference to FIG. 7.

Referring now to FIG. 7, a call flow diagram of an exemplary scenario where an incoming call is received for the FCD 110 is shown in accordance with an embodiment of the present invention. A caller 602 may dial a user's family number to place a call to the FCD 110. The incoming call from the caller 602 is routed to the PSTN 160 at step 708. In response to the incoming call, a first invite message is generated and routed to the server 150 via a signaling gateway 612 at step 714. The server 150 sends a fourth invite message corresponding to the incoming call to the FCD 110 via the signaling gateway 612 at step 716. The FCD 110 responds by ringing, and the caller 602 is informed about the ringing via the signaling gateway 612 and the PSTN 160 at step 718.

If the DMCD 125 and the FCD 110 are in a predetermined area, the server 150 obtains the personal number corresponding to the DMCD 125 from a user profile database. Specifically, the user profile database comprises at least a personal number and a family number assigned to a user. The server can use the family number to obtain the associated personal number. The server 150 communicates with a HLR 616 of the GSM servicing the DMCD 125 to obtain a MSRN corresponding to the personal number at step 726. The HLR 616 can coordinate with the MSC 145 of the DMCD 125 in order to obtain the MSRN. The server 150 forwards the MSRN of the DMCD 125 to the signaling gateway 612 at step 728. Using the MSRN, the signaling gateway 612 sends a fifth invite message to the DMCD 125 via the MSC 145 and the UNC 140 at step 732. Specifically, the MSC 145 places a page request to the UNC 140 resulting in a traffic channel setup between the UNC 140 and the DMCD 125. Consequently, the caller 602 receives a ringing tone from the DMCD 125 at step 734.

The incoming call can be answered by the DMCD 125 or the FCD 110. However, for illustrative purposes, the incoming call is answered by the DMCD 125 (step 736). The signaling gateway 612 is informed that the DMCD 125 answered the call. The signaling gateway 612 informs the server 150 about the incoming call being answered by the DMCD 125 at step 738. The server 150 sends a cancel ringing message to the FCD 110 via the signaling gateway 612 at step 740. Consequently, the FCD 110 stops ringing.

As described with reference to FIGS. 5 and 7, the present invention enables both the DMCD 125 and the FCD 110 to ring in response to a call for the FCD 110, when both the DMCD 125 and the FCD are in the predetermined area 105. As mentioned earlier, in an embodiment of the present invention, both the DMCD 125 and the FCD 110 ring simultaneously. In an alternate embodiment, the DMCD 125 and the FCD 110 may ring sequentially.

Various embodiments of the present invention provide a system and method for facilitating simultaneous ringing of one or more DMCDs and one or more FCDs. In accordance with various embodiments of the present invention, one or more FCDs can reside within a predetermined area and one or more DMCDs may be roaming outside the predetermined area. When a DMCD enters the predetermined area from an outside area, the present invention facilitates simultaneous ringing of the DMCD and the FCDs in the predetermined area. Further, the present invention provides a user with an option to turn on or turn off the simultaneous ringing feature.

As a result of simultaneous ringing provided by the present invention, the user can answer an incoming call using any of one or more DMCD and one or more FCDs in the predetermined area, irrespective of whom the incoming call was meant for. This results in a call extension behavior across VoIP services and dual-mode services. The present invention, thus, attempts to provide a convergence of VoIP services and dual-mode services for the convenience of users.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for facilitating ringing of at least a dual mode communication device and a fixed communication device in an IP-based communication system, the method comprising:
receiving a first invite message corresponding to an incoming call for one of the dual mode communication device and the fixed communication device
determining whether the dual mode communication device and the fixed communication device are located within a predetermined area;
when the dual mode communication device and the fixed communication device are located within a predetermined area,
determining whether a simultaneous ringing feature is active; and
when the simultaneous ringing feature is active,
enabling both the dual mode communication device and the fixed communication device to join the incoming call simultaneously by sending a second invite message to the dual mode communication device, thereby causing the dual mode communication device to ring and sending a third invite message to the fixed communication device thereby causing the fixed communication device to ring.

2. The method of claim 1, wherein determining whether the dual mode communication device and the fixed communication device are located within a predetermined area comprises:
receiving a location update corresponding to the dual mode communication device, the location update comprising at least a device identifier of the dual mode communication device and an access point identifier of a wireless communication access point;
verifying whether a location of the wireless communication access point corresponds to the predefined area; and
updating a location information of the dual mode communication device based on the predetermined area corresponding to the access point identifier.

3. The method of claim 2, wherein the location update is received from one of an Unlicensed Mobile Access Network Controller (UNC) and the dual mode communication device, the dual mode communication device being registered with the UNC.

4. The method of claim 2, wherein the location update corresponding to the dual mode communication device is received periodically over a predetermined interval of time.

5. The method of claim 4, wherein the location information of the dual mode communication device is reset to a cellular location, if a location update is not sent during the predetermined interval of time.

6. The method of claim 1, wherein when the first invite message is for the dual mode communication device, the enabling step comprises:
obtaining a mobile station roaming number from a home location register;
sending a second invite message to the dual mode communication device using the mobile station roaming number;
requesting a family number corresponding to the fixed communication device from a user profile database; and
sending a third invite message to the family number.

7. The method of claim 1, wherein when the first invite message is for the fixed communication device, the enabling step comprises:
sending a fourth invite message to a family number corresponding to the fixed communication device;
requesting a personal number corresponding to the dual mode communication device from a user profile database;
requesting a mobile station roaming number assigned to the dual mode communication device from a home location register; and
sending a fifth invite message to the dual mode communication device using the mobile station roaming number.

8. The method of claim 1 wherein when the simultaneous ringing feature is not active, the method comprises:
determining whether a sequential ringing feature is active; and
when the sequential ringing feature is active,
sending a second invite message to one of the dual mode communication device and the fixed communication device, thereby causing the one of the dual mode communication device and the fixed communication device to ring; and
when the one of the dual mode communication device and the fixed communication device does not answer the incoming call, sending a third invite message to the other of the dual mode communication device and the fixed communication device, thereby causing the other of the dual mode communication device and the fixed communication device to ring.

9. The method of claim 1 wherein when the dual mode communication device and the fixed communication device are not located within the predetermined area, and wherein when the first invite message is for the dual mode communication device, the method comprises enabling only the dual mode communication device to join the incoming call.

10. The method of claim 1 wherein when the dual mode communication device and the fixed communication device are not located within the predetermined area, and wherein when the first invite message is for the fixed communication device, the method comprises enabling only the fixed communication device to join the incoming call.

11. A server for facilitating ringing of at least a dual mode communication device and a fixed communication device in an IP-based communication system, the server comprising:
a transceiver configured to receive a first invite message corresponding to an incoming call for one of a dual mode communication device and a fixed communication device;
a memory coupled to the transceiver, the memory maintaining at least a family number corresponding to the fixed communication device and a personal number corresponding to the dual mode communication device; and
a processor operatively coupled to the memory, the processor configured to:
determine whether the dual mode communication device and the fixed communication device are located within a predetermined area;
when the dual mode communication device and the fixed communication device are located within a predetermined area, the processor determining whether a simultaneous ringing feature is active; and
when the simultaneous ringing feature is active, enabling both the dual mode communication device and the fixed communication device to join the incoming call simultaneously by sending a second invite message to the dual mode communication device, thereby causing the dual mode communication device to ring and sending a third invite message to the fixed communication device thereby causing the fixed communication device to ring.

12. The server of claim 11, wherein the transceiver, is further configured to:
receive a location update corresponding to the dual mode communication device, the location update comprising at least a device identifier of the dual mode communication device and an access point identifier of a wireless communication access point.

13. The server of claim 12, wherein the processor is further configured to:
verify whether the wireless communication access point corresponds to the predefined area; and
update a location information of the dual mode communication device based on the predetermined area corresponding to the access point identifier.

14. The server of claim 13, wherein the processor is configured to reset the location information of the dual mode communication device to a cellular location, if a location update is not received within a predetermined interval of time.

15. The server of claim 11, wherein when the first invite message is for the dual mode communication device, the server is configured to:
obtain a mobile station roaming number from a home location register;
send a second invite message to the dual mode communication device using the mobile station roaming number;
access a family number corresponding to the fixed communication device from a user profile database; and
send a third invite message to the family number.

16. The server device of claim 11, wherein when the first invite message is for the fixed communication device, the server is configured to:
send a fourth invite message to a family number corresponding to the fixed communication device;
access a personal number corresponding to the dual mode communication device;
request a mobile station roaming number assigned to the dual mode communication device from a home location register; and
send a fifth invite message to the dual mode communication device using the mobile station roaming number.

17. The server of claim 11 wherein when the simultaneous ringing feature is not active, the processor is configured to:
determine whether a sequential ringing feature is active; and
when the sequential ringing feature is active,
send a second invite message to one of the dual mode communication device and the fixed communication device, thereby causing the one of the dual mode communication device and the fixed communication device to ring; and
when the one of the dual mode communication device and the fixed communication device does not answer the incoming call, send a third invite message to the other of the dual mode communication device and the fixed communication device, thereby causing the other of the dual mode communication device and the fixed communication device to ring.

18. The server of claim 11 wherein when the dual mode communication device and the fixed communication device are not located within the predetermined area, and wherein when the first invite message is for the dual mode communication device, the processor is configured to enable only the dual mode communication device to join the incoming call.

19. The server of claim 11 wherein when the dual mode communication device and the fixed communication device are not located within the predetermined area, and wherein when the first invite message is for the fixed communication device, the processor is configured to enable only the fixed communication device to join the incoming call.
